(19) United States
(12) Patent Application Publication
(10) Pub. No.: US 2011/0318087 A1
(43) Pub. Date: Dec. 29, 2011

(54) Safety Device for Window Shades

(75) Inventors: Yu-Che Wen, Taoyuan County (TW); Chao-Hung Nien, Taichung City (TW)

(73) Assignee: Nien Made Enterprise Co., Ltd., Taichung City (TW)

(21) Appl. No.: 12/823,744

(22) Filed: Jun. 25, 2010

(51) Int. Cl. F16G 11/00

(52) U.S. Cl. 403/2

(57) ABSTRACT

A safety device for window shades sets on a lift cord system for window shades. The safety device includes a fastener and a sliding sleeve. The fastener includes a sleeve and a first connecting end and a second connecting end respectively defined on two ends of the sleeve. The sleeve at least has one first entrance. The connecting end connects with one end of the lift cord system. The first connecting end has a first groove defining a cavity thereof and a first opening formed on an end portion of the first connecting end and connected with the first groove. A first guiding groove extends from the first entrance to the first opening. The first connecting end is divided along lines from the first entrance, the first guiding groove to the first opening to form two petal-shaped pieces with elastic deformation to expand the first opening.

### BACKGROUND OF THE INVENTION

1. Field of the Invention

The present invention relates to a safety device for window shades, and in particular, to a safety device for window shades which utilizes a fastener and a sliding sleeve to adjust the elastic deformation of the safety device so as to release a lift cord.

2. The Related Art

A conventional window shade, such as a roller shade, a roman shade or a venetian shade and so on, uses a closed lift cord system to control the raising or lowering of the slats of a window shade so as to generate different light transmission. Moreover, the lift cords must have certain toughness in order to bear the weight of the window shade and the driving force of acceleration when the window shade is lifted for adjusting the light transmission. However, such closed lift cord systems used for window shades are so unsafe that tragedies always happen, for example, children may be caught in their necks by the lift cords when playing around the window shades.

### SUMMARY OF THE INVENTION

An object of the present invention is to provide a safety device for being connected with a closed lift cord system of a window shade. When a pull force applied on the lift cord system is beyond the load ability of the lift cord system, the safety device produces deformation and the lift cord is released, thereby the closed lift cord system is opened. Another object of the present invention is to adjust the deformation of the safety device via a detachable sliding member thereby ensuring that window shades can be applied in many different environments.

To achieve the above-mentioned objects, a safety device for window shades which is set on a lift cord system for window shades is provided. The safety device includes a fastener. The fastener includes a sleeve and a first connecting end and a second connecting end respectively defined on two ends of the sleeve. The sleeve at least has a first entrance. The first connecting end has a first groove defining a cavity thereof and a first opening formed in an end portion of the first connecting end and connected with the first groove. A first guiding groove extends from the first entrance to the first opening. The second connecting end connects with the second lift cord end. The second connecting end has a second cavity thereof. The first connecting end is divided along lines of the first entrance, the first guiding groove to the first opening to form petal-shaped pieces with elastic deformation to expand the first opening to release the first block and thus break the connection between the first lift cord end and the second lift cord end.

The present invention has the features as follows: based on defining the groove in the fastener to receive the clasp bead (that is, the block) of the lift cord system set on the window shade, the operation is simplified; the opening with elastic deformability (the aperture of the opening is smaller than the diameter of the clasp bead) is defined in the groove to ensure that the clasp bead can be pulled out from the fastener so as to release the lift cord when the lift cord system works under a pull force beyond the elastic deformability of the opening; and the releasing strength of the safety device can be adjusted based on the diameter of the clasp bead or the thickness of the inner wall of the fastener. Moreover, the present invention mounts the detachable sliding sleeve on the surface of the fastener to provide different inhibiting effects on the deformation of the opening of the fastener according to different positions of the sliding sleeve on the surface of the fastener (the closer the sliding sleeve is located to the opening, the better the inhibiting effect is, and the greater the pull force is needed to release the lift cord of the safety device), thereby improving the ability of adjusting the releasing strength of the safety device on the lift cord and extending the application range of the safety device.

### BRIEF DESCRIPTION OF THE DRAWINGS

FIG. 1 is a right side view of an embodiment of a safety device for window shades according to the present invention applied on a lift cord system of a roller shade;

FIG. 2 is a partially magnified perspective view of FIG. 1 from the back side;

FIG. 3 is a front side view of a fastener of the embodiment of the safety device for window shades according to the present invention;

FIG. 4 is a perspective view of the fastener of the embodiment of the safety device for window shades according to the present invention;

FIG. 5 is an exploded view of a fastener of another embodiment of the safety device for window shades according to the present invention;

FIG. 6 is an assembled view of the fastener of FIG. 5;

FIG. 7A is an exploded view of a fastener of an embodiment of the safety device for window shades according to the present invention;

FIG. 7B is an assembled view of the fastener of the third embodiment of the safety device for window shades according to the present invention;

FIG. 8, FIG. 9 and FIG. 10 are action schematic views showing that the safety device for window shades according to the present invention combines with a lift cord system;

FIG. 11 is an action schematic view showing that the safety device for window shades according to the present invention combines with a bead chain lift cord system;

FIG. 12 and FIG. 13 are action schematic views showing that the safety device for window shades according to the present invention is detached from the lift cord system;

FIG. 14 is a schematic view of the safety device for window shades according to the present invention combining with the lift cord system and a second block received in a second opening;

FIG. 15 is an action schematic view of the second block released from the second opening of FIG. 14;

FIG. 16 is a perspective view of the safety device for window shades according to the present invention with a sliding sleeve;

FIG. 17 is a top view of the sliding sleeve in FIG. 16;

FIG. 18 is a schematic view of the sliding sleeve of the safety device for window shades according to the present invention permitting releasing the lift cord;

FIG. 19 is a schematic view of the sliding sleeve of the safety device for window shades according to the present invention forbidding releasing the lift cord;

FIG. 20 is a side view of a fastener and a sliding sleeve of another embodiment of the safety device for window shades according to the present invention;

FIG. 21A is an exploded view of a sliding sleeve in another embodiment of the safety device for window shades according to the present invention; and

FIG. 21B is an assembled view of the sliding sleeve in another embodiment of the safety device for window shades according to the present invention.

### DETAILED DESCRIPTION OF THE PREFERRED EMBODIMENT

Detailed description will hereunder be given of the preferred embodiments of a safety device for window shades according to the present invention with reference to the accompanying drawings. All the drawings are simplified and they are only cited to show the basic structure of the present invention. Hence, only the parts related to the present invention are marked in the drawings, and the parts in the drawing aren't shown depending on actual number, shapes, sizes during actual implement of the present invention. The changes may be made in size and the arrangement of the parts may be more complex when the present invention is actualized.

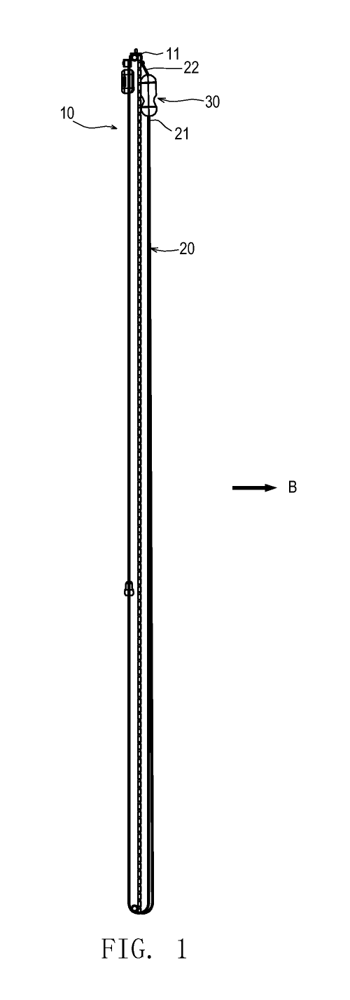

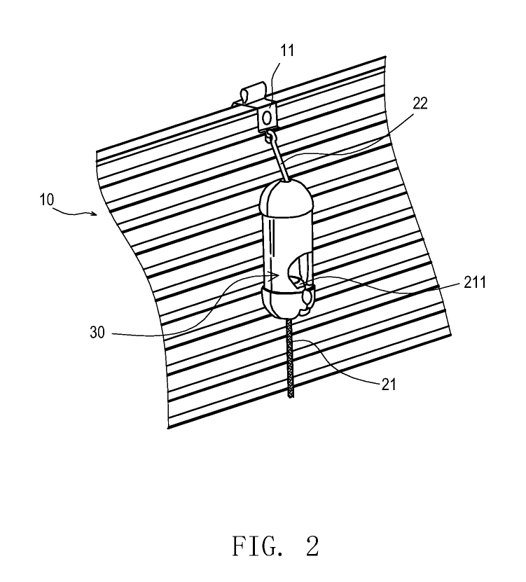

Please refer to FIG. 1 and FIG. 2. FIG. 1 is a right side view of an embodiment of the safety device for window shades according to the present invention applied on a lift cord system of a roller shade. FIG. 2 is a partially enlarged perspective view of FIG. 1 from the back side. The safety device for window shades is set on a lift cord system close to a fixed member 11 on a back side B of a window shade 10 in the embodiment. The safety device can also be set on any position of the closed lift cord system according to the present invention. The window shades used in the present invention can be, but not limited to, a roller shade, a roman shade or a venetian shade. The lift cords used in the present invention can be a string or a bead chain.

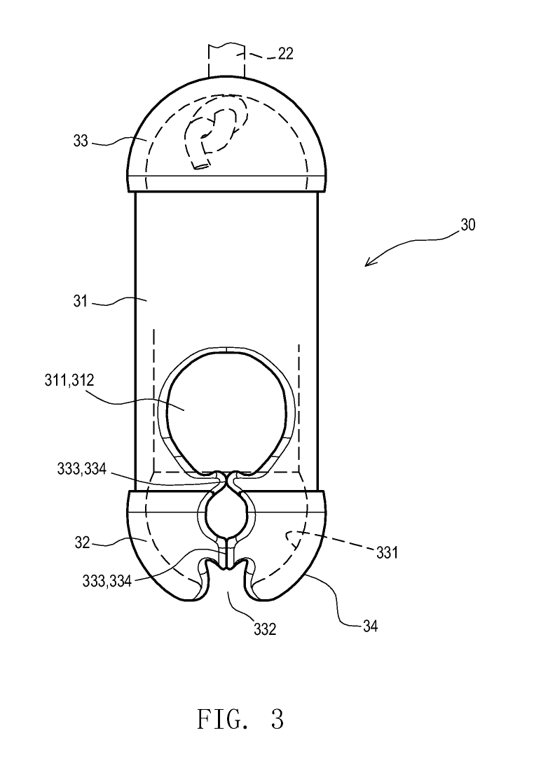

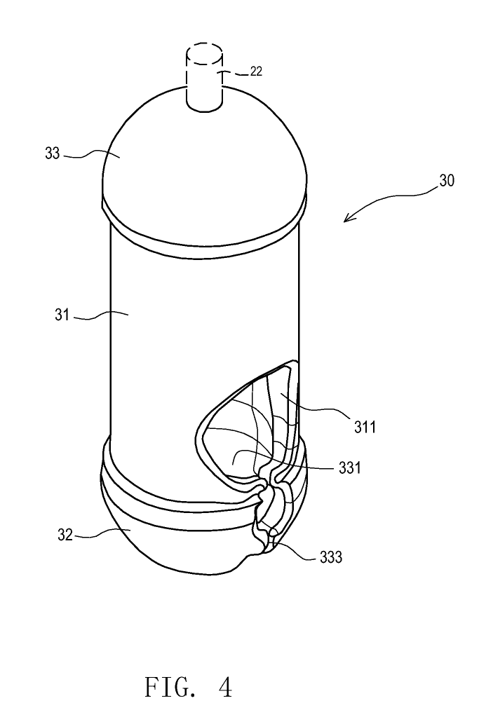

Referring to FIG. 3 and FIG. 4, FIG. 3 is a front side view of a fastener of the safety device for window shades according to the present invention. FIG. 4 is a perspective view of the fastener of the safety device for window shades according to the present invention. In this embodiment, the safety device for window shades is set between the first lift cord end 21 and the second lift cord end 22 of the lift cord system 20 on the window shade 10. In addition, a first block 211 is formed on the first lift cord end 21, which is a clasp bead in a preferred embodiment.

The safety device includes a fastener 30. The fastener 30 has a sleeve31 (the sleeve 31 is a long sleeve in this embodiment, but it is not limited to), a first connecting end 32 defined on one axial end of the sleeve 31 and a second connecting end 33 defined on the other axial end of the sleeve 31. The sleeve 31 has a first entrance 311 and/or a second entrance 312 to allow the first block 211 formed on the first lift cord end 21 to enter the sleeve 31. The second connecting end 33 is used to be connected with the second lift cord end 22. A first groove 331 (preferably, a spherical groove) defines a cavity of the first connecting end 32 to receive the first block 211. It is noted that the embodiment can also only have the first entrance 311 without the second entrance 312 to receive the first lift cord end 21 or the first block 211. However, since the forming of the second entrance 312 can increase the number of entrances and adjust a releasing force of deformation of the first connecting end 32 (it will be described further), the following description is given based on this embodiment with the second entrance 312.

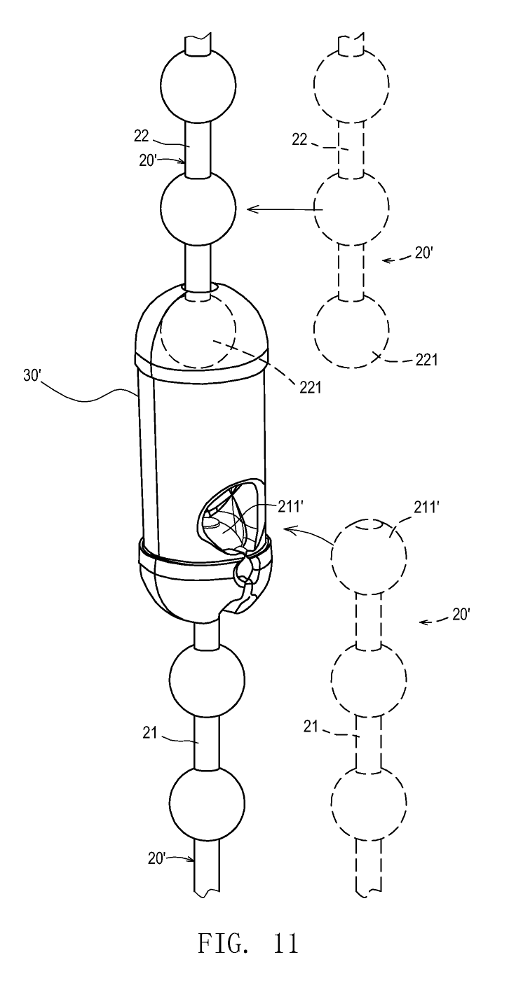

A first opening 332 is formed in the first connecting end 32 and connected with the first groove 331. The aperture of the first opening 332 is smaller than the diameter of the first block 211 so as to keep the first block 211 in the first groove 331. A first guiding groove 333 extends from the first entrance 311 to the first opening 332. A second guiding groove 334 extends from the second entrance 312 to the first opening 332. The first connecting end 32 is divided along the lines of the first entrance 311, the first guiding groove 333, the first opening 332, the second guiding groove 334 and the second entrance 312 to form two petal-shaped pieces 34 which can be expanded due to their elastic deformation to expand the first opening to release the first block and thus break the connection between the first lift cord end and the second lift cord end. When the lift cord system 20 works under a pull force, the pull force is transmitted to the first block 211 along the lift cord system 20 so that the first opening 332 generates elastic deformation to expand its diameter. Once the pull force is larger than the load force, the first block 211 will be pull out and released from the first opening 332 so as to relieve the pull force acting on the lift cord system 20, as show in FIG. 12 and FIG. 13. Moreover, a first expanding hole 3331 is defined in a partial portion of the first guiding groove 333 and a second expanding hole 3341 is defined in a partial portion of the second guiding groove 334. The elastic deformation of the first opening 332 can be further adjusted via the first expanding hole 3331 and the second expanding hole 3341, so that a load pull force of the lift cord system can be changed, and the pull force which acts on the lift cord system 20 can be easier or not easier to be relieved.

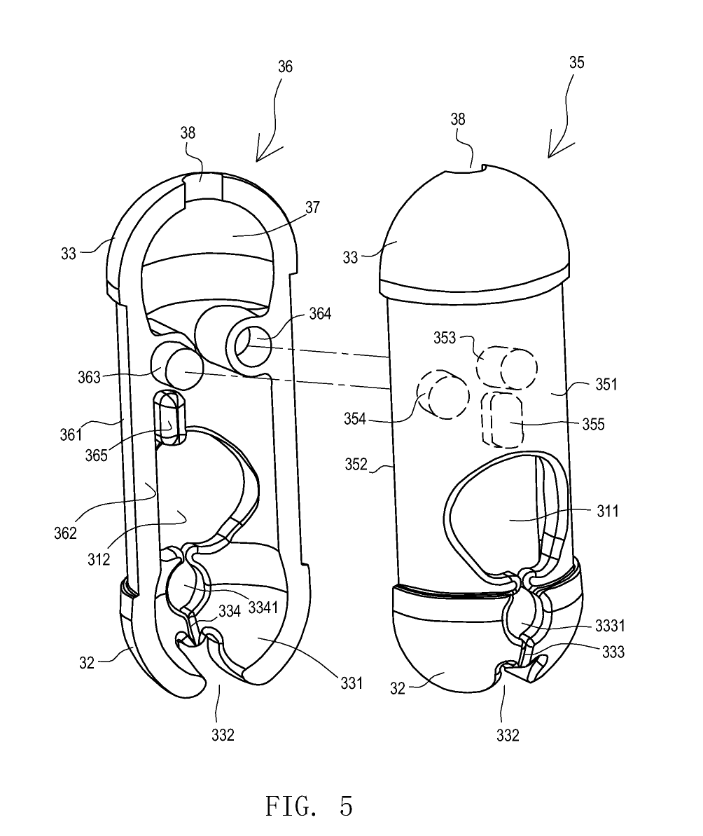

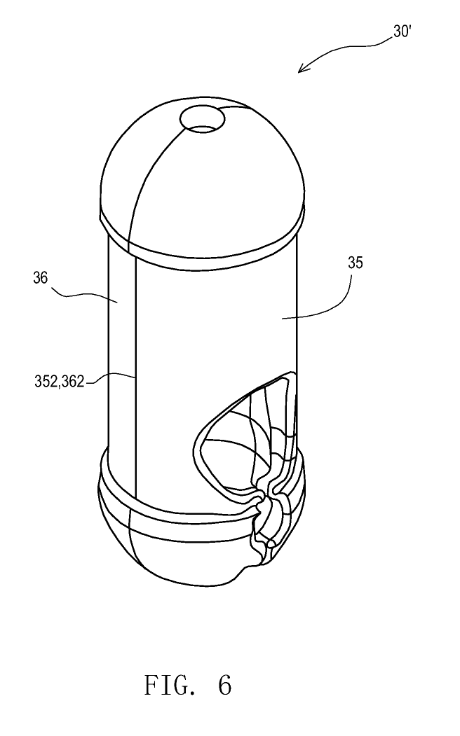

Please refer to FIG. 5 and FIG. 6. The fastener 30′ of another embodiment of the present invention includes a first fasten body 35 and a second fasten body 36. The first fasten body 35 and the second fasten body 36 engage with each other in the radial direction. The first fasten body 35 and the second fasten body 36 may be completely symmetrical. The first fasten body 35 is a first shell 351 which has a first connecting face 352 for connecting with the second fasten body 36, a first pin 353 protruding from the first connecting face 352, a first pin hole 354 recessed in the first connecting face 352, a first entrance 311, a first guiding groove 333 and a half first opening 332. The second fasten body 36 is a second shell 361 which has a second connecting face 362, a second pin 363 protruding from the second connecting face 362, a second pin hole 364 recessed in the second connecting face 362, a second entrance 312, a second guiding groove 334 and the other half first opening 332. When the first fasten body 35 and the second fasten body 36 are assembled together, the first connecting face 352 engages with the second connecting face 362, and the first pin 353 is inserted into the second pin hole 364 and the second pin 363 is inserted into the first pin hole 354 to connect the first fasten body 35 and the second fasten body 36.

In the above described embodiment, the first pin 353 and the first pin hole 354 are set symmetrically about the central axis of the first shell 351, the second pin 363 and the second pin hole 364 are also set symmetrically about the central axis of the second shell 361. Also, a first reinforcing rib 355 protrudes from the first connecting face 352 outside of the first pin 353 and a second reinforcing rib 365 protrudes from the second connecting face 362 outside of the second pin 363 so as to improve the engagement strengthen of the first shell 351 and the second shell 361.

Certainly, the pins and pin holes are used to assemble the first shell 351 and second shell 361. Although in the above described embodiment, the shells each has one pin and one pin hole, it can also be changed by one shell with two pin holes and the other shell with two pins.

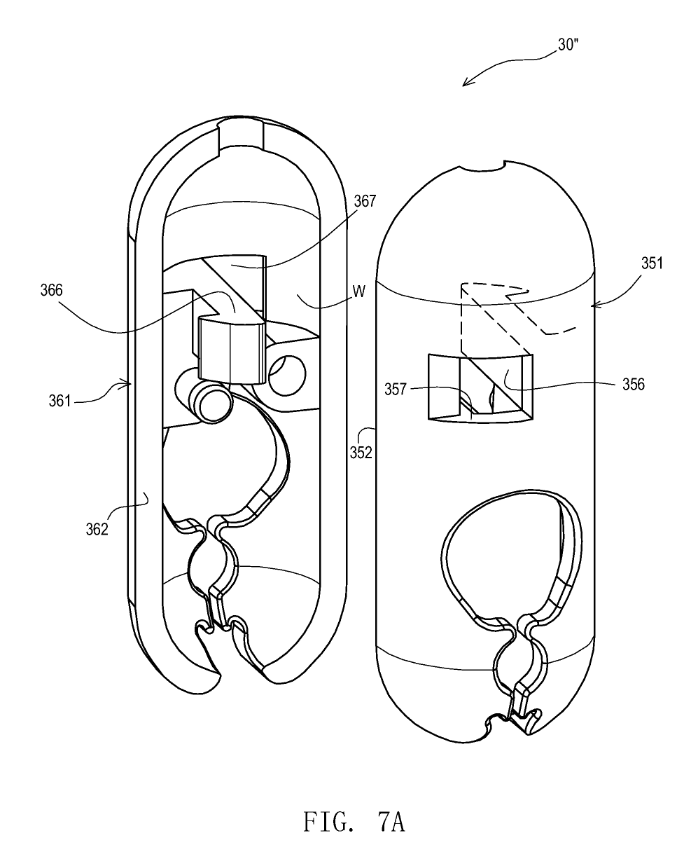

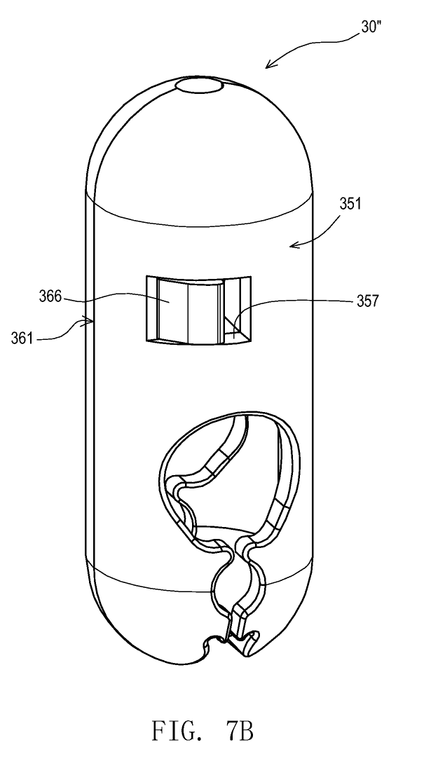

Referring to FIG. 7A and FIG. 7B, the first shell 351 of the fastener 30″ may further include a first hook 356 protruding radially from the first connecting face 352 and a first slot 357 defined in the inner wall W of the first shell 351. The second shell 361 further includes a second hook 366 protruding radially from the second connecting face 362 and a second slot 367 defined in the inner wall W of the second shell 361. The position of the second hook 366 corresponds to that of the first slot 357, and the position of the second slot 367 corresponds to that of the first hook 356. When the first connecting face 352 engages with the second connecting face 362, the first hook 356 hooks the second slot 367 and the second hook 366 hooks the first slot 357 so as to improve the fastening strengthen of the fastener 30″.

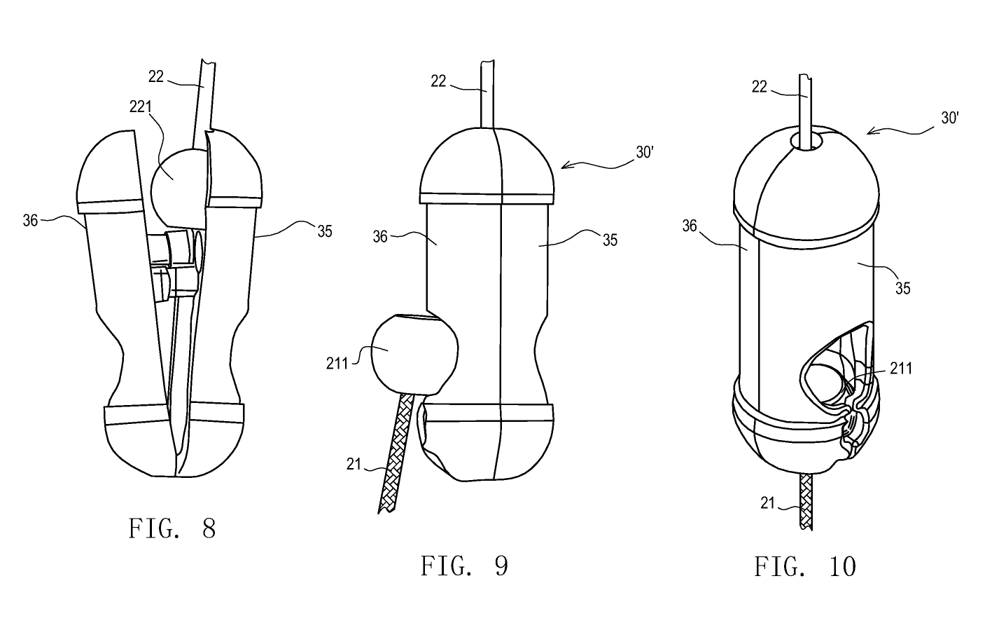

Refer to FIG. 8 to FIG. 10. The second lift cord end 22 further has a second block 221 (it may be a clasp bead or a knot) disposed thereon in the embodiment in which the fastener 30′ includes the radially engaged first fasten body 35 and second fasten body 36. A second cavity 37 is formed in the second connecting end 33 of the fastener 30′, by the first fasten body 35 and the second fasten body 36. A lift cord hole 38 connected with the second cavity 37 is defined in the end portion of the second connecting end 33. The second block 221 is received in the second cavity 37, and the second lift cord end 22 extends out from the lift cord hole 38. That's the way of the second connecting end 33 connected with the second lift cord end 22.

Referring to FIG. 11, the lift cord system 20′ may also be a bead chain system in the above described embodiment and the first block 211′ and the second block 221′ is formed by the bead chains of the bead chain string.

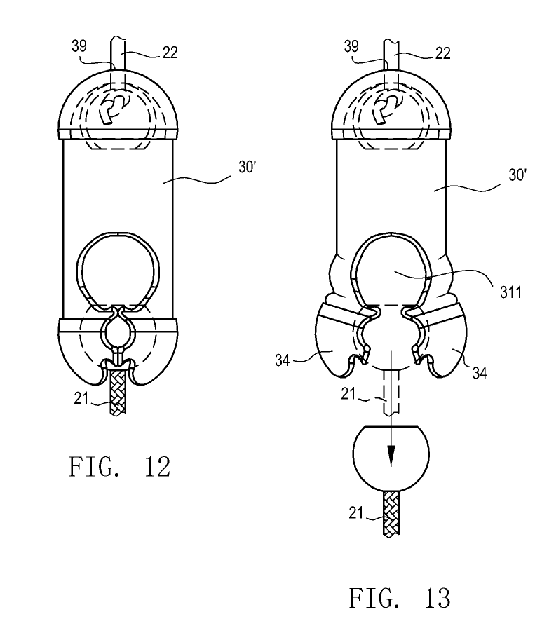

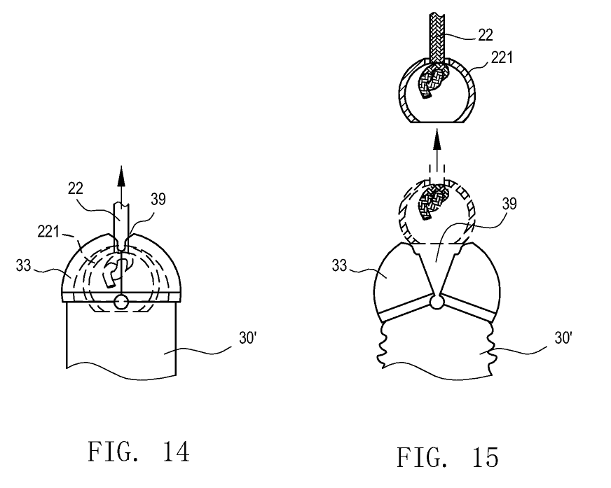

Please refer to FIG. 12 to FIG. 15. It is noted that the above-mentioned string hole 38 only provides the function of connecting with the fasten 30′, and it can be expanded to be a second opening 39 under the effect of a force, thereby providing the function of relieving the pull force.

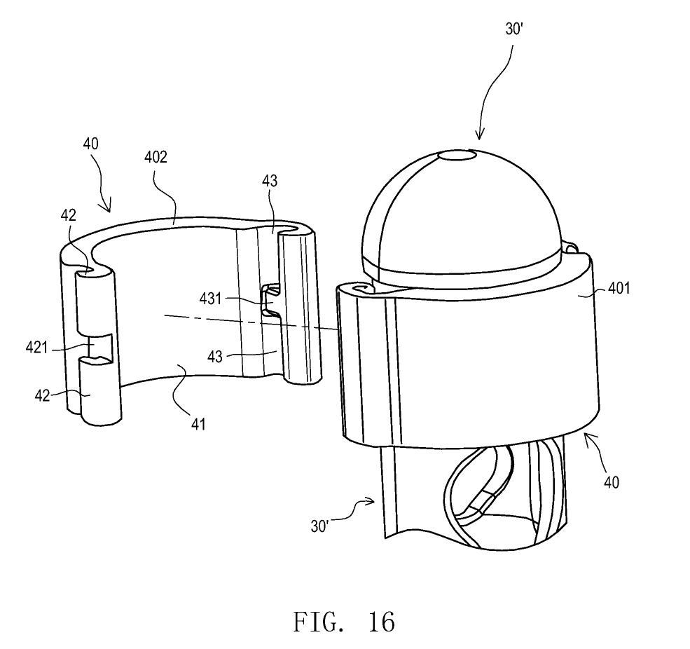

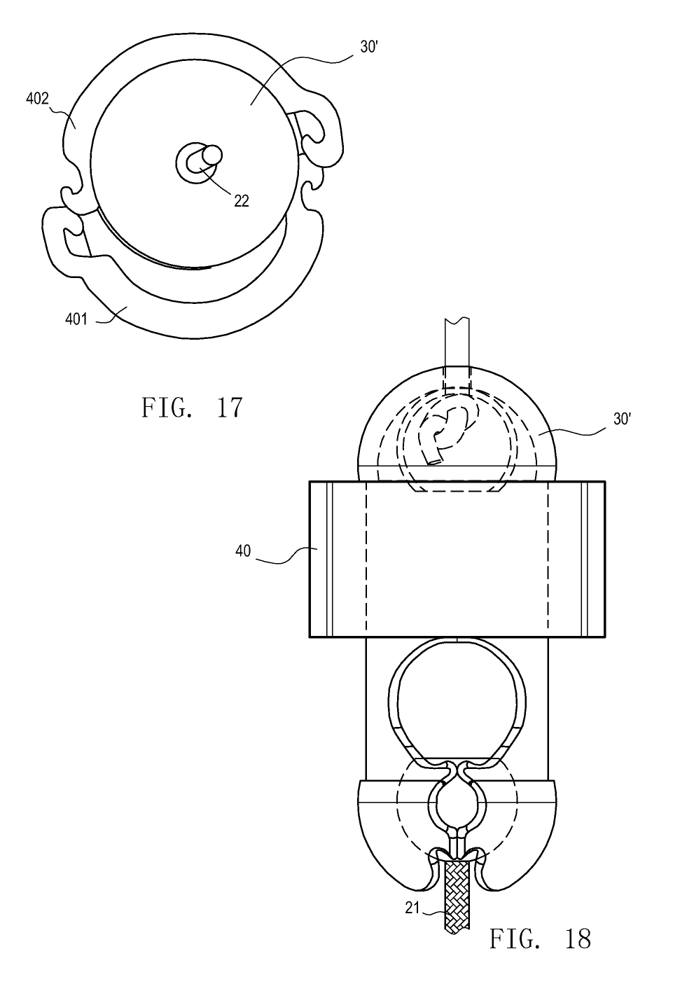

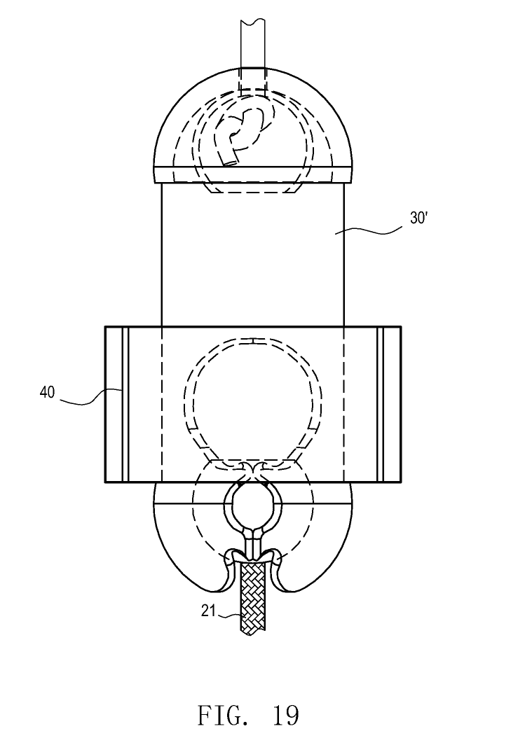

Refer to FIG. 16 to FIG. 19. The above-described fastener 30 or 30′ may further include a sliding sleeve 40 radially fastened on the outer surface thereof. The sliding sleeve 40 includes a first sliding sleeve member 401 and a second sliding sleeve member 402 which fasten each other. The shape of the inner surface 41 of the sliding sleeve 40 is generally identical as that of the outer surface of the fastener 30 or 30′ so as to form a sliding fit. In a preferred embodiment, the outer surface of the fastener 30 or 30′ is circular. The first sliding sleeve member 401 and the second sliding sleeve member 402 may be symmetrical completely. The first sliding sleeve member 401 and the second sliding sleeve member 402 each has a hook part 42 extending axially along the whole height thereof and a recess 43 extending axially. A radial groove 421 is formed in the hook part 42. A radial rib 431 is formed in the recess 43. When the first sliding sleeve member 401 and the second sliding sleeve member 402 are assembled together, they can slide synchronously on the outer surface of the fastener 30 or 30′ under the effect of an external force. When the sliding sleeve 40 is fixed on one side of the fastener 30 or 30′, close to the first connecting end 32, the first entrance 311 and the second entrance 312 can be closed by the sliding sleeve 40, and the elastic deformation of the first opening 332 of the first connecting end 32 is restricted by the sliding sleeve 40, so the first block 211 cannot be released. When the sliding sleeve 40 slides axially and is fixed on the other side of the fastener 30, 30′, close to the second connecting end 33, the first entrance 311 and the second entrance 312 are opened, and the elastic deformation of the first opening 332 of the first connecting end 32 is not restricted by the sliding sleeve 40, so the first block 211 can be released. The sliding sleeve 40 can be fixed in a position between the first connecting end 32 and the second connecting end 33 to adjust the releasing strength on the first block 211.

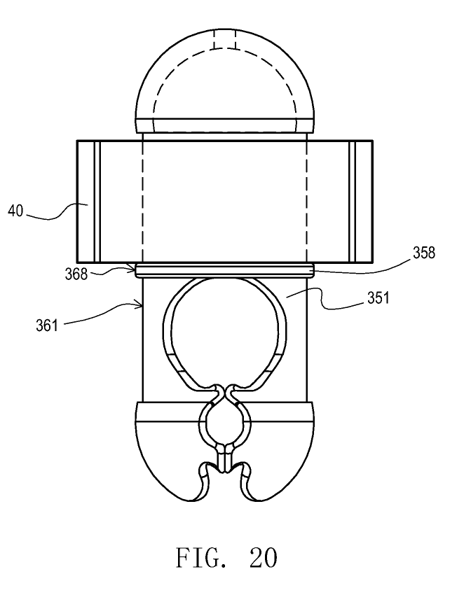

As show in FIG. 20, on the other hand, in order to prevent the sliding sleeve 40 from sliding down under the effect of an exterior force (for example, pulled by children), which causes that the function of releasing the lift cord is turned off, a first outer rib 358 may be formed on the surface of the first shell 351 and a second outer rib 368 may be formed on the surface of the second shell 361. When the first shell 351 and the second shell 361 are assembled, the first outer rib 358 and the second outer rib 368 surround the sleeve 31 to prevent the sliding sleeve 40 from sliding down, thereby ensuring that the function of releasing the lift cord can be turned on.

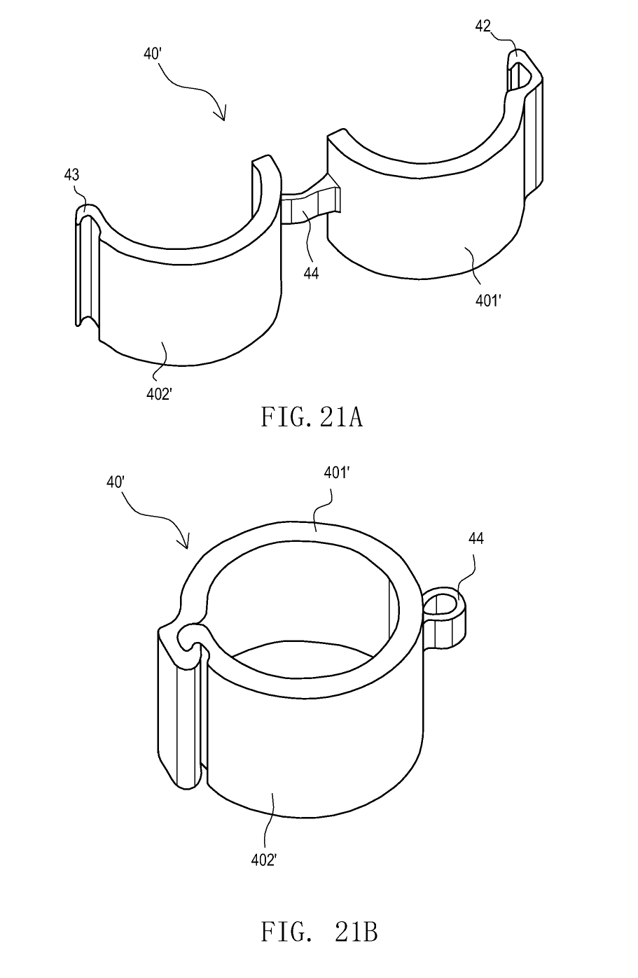

Refer to FIG. 21A and FIG. 21B. In another embodiment, a sliding sleeve 40′ includes a first sliding sleeve member 401′ and a second sliding sleeve member 402′ which are connected to be a whole part via a connecting potion 44 made of a flexible material. The first sliding sleeve member 401′ has a hook part 42 extending axially along the whole height thereof and the second sliding sleeve member 402′ has a recess 43 extending axially for engaging with the hook part 42.

As described above, the present invention has the features as follows: based on defining the groove in the fastener to receive the clasp bead of the lift cord system set on the window shade, the operation is simplified; the opening with elastic deformability is defined in the groove to ensure that the clasp bead can be pulled out from the fastener so as to release the lift cord when the lift cord system works under a pull force beyond the elastic deformability of the opening; and the releasing strength of the safety device can be adjusted based on the diameter of the clasp bead or the thickness of the inner wall of the fastener. Moreover, the present invention mounts the detachable sliding sleeve on the surface of the fastener to provide different inhibiting effects on the deformation of the opening of the fastener according to different positions of the sliding sleeve on the surface of the fastener (the closer the sliding sleeve is located to the opening, the better the inhibiting effect is, and the greater the pull force is needed to release the lift cord of the safety device), thereby improving the ability of adjusting the releasing strength of the safety device on the lift cord and extending the application range of the safety device.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A safety device for window shades, which is set between a first lift cord end and a second lift cord end of a lift cord system for window shades, wherein said first lift cord end has a first block, said safety device comprising:
a fastener, comprising:
a sleeve, at least having a first entrance;
a first connecting end, defined on one end of said sleeve; a first groove defining a cavity thereof for receiving said first block; a first opening formed in an end portion of the first connecting end and connected with said first groove, a first guiding groove extending from said first entrance to said first opening; and
a second connecting end, defined on the other end of said sleeve for being connected with said second lift cord end, and having a second cavity thereof;
wherein said first connecting end is divided along lines from said first entrance, said first guiding groove to said first opening to form petal-shaped pieces with elastic deformation to expand said first opening to release said first block and thus break the connection between said first lift cord end and said second lift cord end.

2. he safety device for window shades as claimed in claim 1, wherein said sleeve has a second entrance corresponding to said first entrance, and a second guiding groove extends from said second entrance to said first entrance so that said first connecting end is divided along the lines of said first entrance, said first guiding groove, said first opening, said second guiding groove and said second entrance to form two petal-shaped pieces with elastic deformation to expand said first opening.

3. The safety device for window shades as claimed in claim 1, wherein said lift cord system for window shades includes a lift cord or a bead chain, and a second opening is defined on an end portion of said second connecting end, connects with said second cavity and can be elastically expanded under an external force.

4. The safety device for window shades as claimed in claim 1, wherein said lift cord system for window shades includes a lift cord or a bead chain, said first groove is a spherical groove, and said first block is a clasp bead, a knot or a bead chain disposed on the bead chain.

5. The safety device for window shades as claimed in claim 1, wherein a first expanding hole is defined in a partial portion of said first guiding groove.

6. The safety device for window shades as claimed in claim 2, wherein a second expanding hole is defined in a partial position of said second guiding groove.

7. The safety device for window shades as claimed in claim 1, wherein said fastener includes a first fasten body and a second fasten body, and said first fasten body and said second fasten body engage with each other in a radial direction.

8. The safety device for window shades as claimed in claim 2, wherein said fastener includes a first fasten body and a second fasten body, and said first fasten body and said second fasten body engage with each other in a radial direction.

9. The safety device for window shades as claimed in claim 8, wherein said first fasten body and said second fasten body are completely symmetrical.

10. The safety device for window shades as claimed in claim 8, wherein said first fasten body is a first shell which has a connecting face, a first pin protruding from said first connecting face, a first pin hole recessed in said first connecting face, the first entrance, the first guiding groove and the first opening in half; said second fasten body is a second shell which has a second connecting face, a second pin protruding from said second connecting face, a second pin hole recessed in said second connecting face, the second entrance, the second guiding groove and the other half first opening; and said first connecting face engages with said second connecting face, and said first pin is inserted into said second pin hole and said second pin is inserted into said first pin hole to connect said first fasten body and said second fasten body.

11. The safety device for window shades as claimed in claim 10, wherein said first pin and said first pin hole are set symmetrically about a central axis of said first shell, and said second pin and said second pin hole are set symmetrically about a central axis of said second shell.

12. The safety device for window shades as claimed in claim 10, wherein a first reinforcing rib protrudes from said first connecting face outside said first pin.

13. The safety device for window shades as claimed in claim 10, wherein a second reinforcing rib protrudes from said second connecting face outside said second pin.

14. The safety device for window shades as claimed in claim 10, wherein a first outer rib is formed on a surface of said first shell and a second outer rib is formed on a surface of said second shell, and when said first shell and said second shell are engaged, said first outer rib and said second outer rib surround said sleeve.

15. The safety device for window shades as claimed in claim 10, wherein said first shell further includes a first hook protruding radially from said first connecting face and a first slot defined in an inner wall of said first shell; the second shell further includes a second hook protruding radially from said second connecting face and a second slot defined in an inner wall of said second shell; and the position of said second hook corresponds to the position of said first slot and the position of said second slot corresponds to the position of said first hook, so that said first hook and said second hook respectively hook said second slot and said first slot when said first connecting face engages with said second connecting face.

16. The safety device for window shades as claimed in claim 3, wherein said second lift cord end has a second block disposed thereon, and said second block is received in said second cavity and said second lift cord end extends out from said lift cord hole, said second cavity is a spherical groove, and said second block is a clasp bead, a knot or a bead chain disposed on the bead chain.

17. The safety device for window shades as claimed in claim 1, further comprising a sliding sleeve radially fastened on an outer surface of said fastener and including a first sliding sleeve member and a second sliding sleeve member which fasten each other, a shape of an inner surface of said sliding sleeve is generally identical as a sectional shape of said outer surface of said fastener to form a sliding fit.

18. The safety device for window shades as claimed in claim 17, wherein said first sliding sleeve member and said second sliding sleeve member of said sliding sleeve are symmetrical completely, and said first sliding sleeve member and said second sliding sleeve member each has a hook part extending axially along the whole height thereof and a recess extending axially, and a radial groove is formed in said hook part and a radial rib is formed in said recess so that said first sliding sleeve member and said second sliding sleeve member can slide synchronously on the outer surface of said fastener under the effect of an external force when they are assembled together.

19. The safety device for window shades as claimed in claim 18, wherein when said sliding sleeve slides axially and is fixed on one side of said first connecting end of said fastener, said first entrance and said second entrance are closed by said sliding sleeve; and when said sliding sleeve slides axially and is fixed on one side of said second connecting end, said first entrance and said second entrance are opened.

20. The safety device for window shades as claimed in claim 17, wherein said first sliding sleeve member and said second sliding sleeve member are connected to be a whole part via a connecting potion made of a flexible material, and said first sliding sleeve member has a hook part extending axially along the whole height thereof and said second sliding sleeve member has a recess extending axially for engaging with said hook part.
